(19) United States
(12) Patent Application Publication
(10) Pub. No.: US 2003/0041598 A1
(43) Pub. Date: Mar. 6, 2003

(54) Double racks and pinion type rotary actuator

(75) Inventors: Kiyoshi Takeuchi, Tsukuba-gun (JP); Mitsunori Magaribuchi, Tsukuba-gun (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: SMC Corporation, Tokyo (JP)

(21) Appl. No.: 10/217,440

(22) Filed: Aug. 14, 2002

(30) Foreign Application Priority Data
Aug. 28, 2001 (JP) 2001-258329

(51) Int. Cl. F15B 7/00

(52) U.S. Cl. 60/591

(57) ABSTRACT

Of first and second two pressure chambers which are respectively formed on both sides of a first rack and a second rack, incompressible liquid is filled in the second pressure chambers which are positioned on the sides of back pressure at a driving time of the racks, and the second pressure chambers of the both racks are caused to communicate with each other via a throttle.

### TECHNICAL FIELD

The present invention relates to a double racks and pinion type rotary actuator which generates a rotational force by applying air pressure thereto.

### PRIOR ART

A conventional double racks and pinion type rotary actuator of this type has a constitution that racks, each having pistons at both ends thereof, are slidably accommodated in two cylinder holes inside a body, respectively, and these racks mesh with a pinion. Then, these racks are driven in a reciprocating manner with synchronism with each other in directions opposed to each other by applying air pressure to pressure chambers positioned on both sides of each rack alternately so that the pinion and a main shaft fixed thereto are rotated in a reciprocating manner.

Now, since air used for driving is compressible, such a double racks and pinion type rotary actuator, is susceptible to such an influence as fluctuations of driving speeds of the racks and the main shaft due to the compressibility of air. In particular, in such a case that the racks are driven at a low speed by low pressure compressed air, the sliding speeds of the racks, and therefore the rotating speed of the main shaft becomes susceptible to influence due to load fluctuation, change of a sliding resistance or the like. As a result, there is such a problem that the main shaft can not be reciprocation-rotated (swung) at a constant speed stably.

### DISCLOSURE OF THE INVENTION

The present invention has been made in view of the above problem, and an object thereof is to provide a double racks and pinion type rotary actuator where influence due to the compressibility of air can be eliminated and racks can be operated at a low speed stably.

Another of the present invention is to provide an actuator where a main shaft can be rotated at a speed adjusted arbitrarily.

The above and other objects and novel features of the present invention will be apparent from the description of the present specification and the attached drawings.

In order to achieve the above object, a rotary actuator according to the present invention is constituted such that, of first and second pressure chambers which are respectively formed on both sides of first and second racks, incompressible liquid is filled in the second pressure chambers which are positioned on sides of back pressure at a driving time of the rack, and the second pressure chambers of the both racks are caused to communicate with each other mutually via a throttle.

In the rotary actuator of the present invention has the above constitution, the two racks are reciprocated in synchronism with each other in directions reverse to each other by alternately supplying compressed air to the first pressure chambers of the racks so that a pinion meshing with the both racks and a main shaft are rotated in a reciprocating manner. At this time, the liquids in the second pressure chambers of both the racks are flowed alternately to the first rack side and the second rack side while their flow rates are being restricted via the throttle. For this reason, by setting the opening amount of the throttle so as to achieve the flow rate necessary for the racks to move at low speed, the driving speeds of the racks, and therefore a swinging rotation speeds of the pinion and the main shaft can be maintained at a constant low speed, and a stable operation thereof can be realized. Also, since the actuator can be driven at low speed using high pressure compressed air which is hardly influenced by a pressure fluctuation or load fluctuation, its operation is further made stable.

According to a specific constitutional aspect of the present invention, the first port and the second port are provided in the first end block, and a communication path and the throttle are provided in a second end block.

Also, in the present invention, adjusting screws for adjusting strokes of the racks are provided at positions in the first end block corresponding to the respective racks so as to be position-adjustable in a state that their distal ends have been protruded in the first pressure chambers.

In the present invention, the throttle may be a variable throttle which can adjust an opening amount or it may be a fixed throttle with a constant opening amount. Also, such a constitution can be employed that a check valve is provided in the communication path in parallel with the throttle and a low speed drive is preformed only in one direction.

Further, in the present invention, liquid may be directly filled in the second pressure chambers, but such a constitution can be employed that bags impermeable to liquid which are stretched/shrunk according to reciprocating movements of the above racks are accommodated in the second pressure chambers and the liquid is filled in the interiors of the bags. In this case, it is unnecessary to additionally provide seal members for sealing the second pressure chambers.

### BRIEF DESCRIPTION OF THE DRAWINGS

FIG. 1 is a sectional view showing a first embodiment of a double racks and pinion type rotary actuator according to the present invention; and

FIG. 2 is a sectional view showing a second embodiment of a double racks and pinion type rotary actuator according to the present invention.

### DETAILED DESCRIPTION

Embodiments of the Present Invention will be Explained Below with Reference to the Drawings.

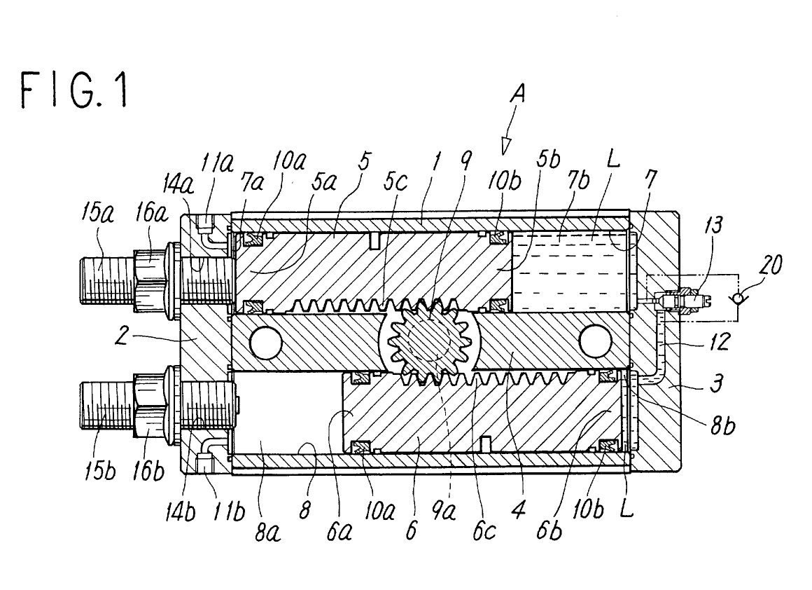

FIG. 1 shows a first embodiment of a double racks and pinion type rotary actuator according to the present invention. A body 1 of the actuator A has a rectangular sectional configuration, first and second two cylinder holes 7, 8 are formed in the body 1 via a intermediate wall 4 in parallel with each other, and both ends of these cylinder holes 7, 8 are closed by a first end block 2 and a second end block 3 mounted to both ends of the body 1.

A first rack 5 and a second rack 6 which cylindrical are accommodated in the cylinder holes 7 and 8 so as to be movable in a reciprocating manner, respectively. The racks 5, 6 have teeth 5c, 6c on inner side faces opposed to each other, these teeth 5c, 6c mesh with a pinion 9 which is rotatably provided to the intermediate wall 4, and a main shaft 9a for outputting a rotational swinging motion is coupled to the pinion 9.

The above first rack 5 and the second rack 6 have first pistons 5a, 6a and second pistons 5b, 6b at both end portions in their axial directions, and piston packings 10a, 10b coming in air-tight contact with inner peripheries of the cylinder holes 7, 8 in a sliding manner are mounted to the pistons 5a, 6a and 5b, 6b. First pressure chambers 7a, 8a are formed between the first pistons 5a, 6a of the both racks 7, 8 and the first end block 2, respectively, and second pressure chambers 7b, 8b are formed between the second pistons 5b, 6b and the second end block 3.

The first pressure chamber 7a of the first rack 5 communicates with a first port 11a opened to one side face of the first end block 2, the first pressure chamber 8a of the second rack 6 communicates with a second port 11b opened to an opposing side face of the first end block 2, and compressed air is supplied to the pressure chambers alternately from the respective ports 11a, 11b.

Also, incompressible liquid L such as water, oil or the like is filled in the second pressure chambers 7b, 8b of the both racks 5, 6. Then, a communication path 12 which puts the second pressure chambers 7b and 8b to communicate with each other is provided in the second end block 3, and a throttle 13 for restricting the flow rate of liquid L flowing in the communication path 12 is provided therein. The throttle 13 is a variable throttle comprising a needle valve which can adjust an opening amount, but it may be a fixed throttle formed by merely reducing the diameter of a portion of the communication path 12.

Adjusting screws 15a, 15b for adjusting strokes of the respective racks 5, 6 are respectively provided in the first end block 2 at positions corresponding to the respective racks 5, 6. These adjusting screws 15a, 15b are screwed in screw holes 14a, 14b formed in the first end block 2 such that their distal ends protrude in the first pressure chambers 7a, 8a, and they can be fixed at required positions by lock nuts 16a, 16b.

Next, operation of the rotary actuator A of the first embodiment will be explained in detail.

As shown in FIG. 1, in a state where the first rack 5 and the second rack 6 are positioned at stroke ends opposed to each other and almost all liquid L has flowed in the second pressure chamber 7b of the first rack 5, when compressed air is supplied from the first port 11a into the first pressure chamber 7a of the first rack 5, the first rack 5 starts rightward movement in the figure due to air pressure of the compressed air. According to the movement of the first rack 5, the liquid L in the second pressure chamber 7b flows into the second pressure chamber 8b of the second rack 6 while it is subjected to flow rate restriction through the flow path 12 and the throttle 13, so that the second rack 6 moves leftward in the figure and air in the first pressure chamber 8a is discharged through the second port 11b to the outside. Then, the pinion 9 meshing with the teeth 5c, 6c rotates in a clockwise direction according to the movements of the both racks 5, 6, and its rotational force is taken out from an output shaft 9a. The movement speeds of the both racks 5, 6, namely the rotation speed of the pinion 9 depends on the flow rate of the liquid L set by the throttle 13.

Next, in a state where the both racks 5, 6 are positioned at stroke ends opposed to the positions shown in FIG. 1, when compressed air is supplied from the second port 11b into the first pressure chamber 8a of the second rack 6, the second rack 6 moves rightward in the figure, so that the liquid L in the second pressure chamber 8b moves into the second pressure chamber 7b of the first rack 5 through the throttle 13, as shown in FIG. 1. The first rack 5 moves leftward and the air in the first pressure chamber 7a is discharged to the outside from the first port 11a, so that the pinion 9 and the main shaft 9b rotates in a counterclockwise direction. The rotation speed at this time also depends on the flow rate of the liquid L set by the throttle 13.

The movement speeds of the both racks 5, 6 can be controlled to required values by adjusting the opening amount in case that the throttle 13 is a variable throttle or by presetting the opening amount in case that the throttle 13 is a fixed throttle.

In the actuator A, thus, by setting the throttle 13 so as to achieve the flow rate required for the racks 5, 6 to move at low speeds, the driving speeds of the racks 5, 6, and, therefore, the swinging rotation speeds of the pinion 9 and the main shaft 9a can be maintained at constant low speeds, so that a stable operation at a low speed can be realized. Also, since the racks 5, 6 can be driven at low speeds by using high pressure compressed air which is hardly influenced by pressure fluctuation and load fluctuation, the operation of the actuator can be stabilized.

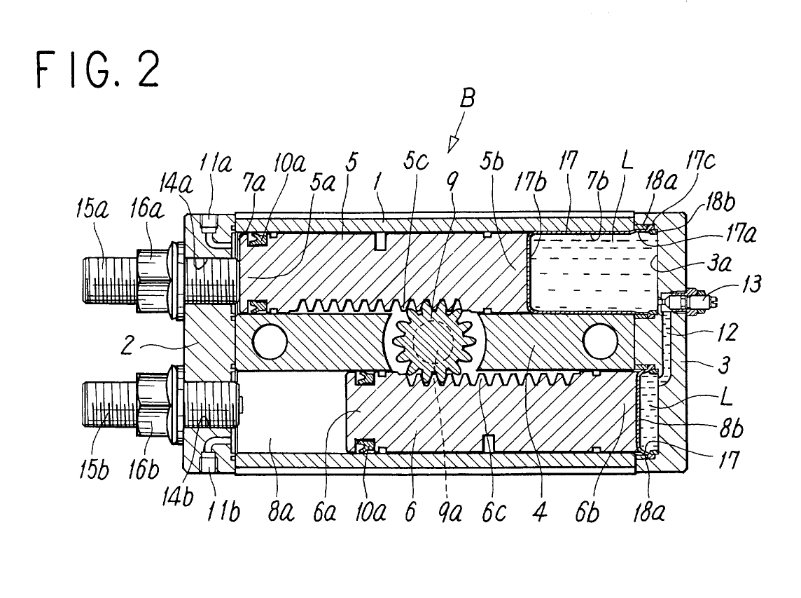

FIG. 2 shows a second embodiment of the present invention, and an actuator B of the second embodiment is different from the actuator A of the first embodiment in that liquid L is directly filled in the second pressure chambers 7b, 8b of the both racks 5, 6 in the first embodiment while liquid L is filled in the second pressure chambers 7b, 8b via bags 17, respectively in the second embodiment.

The bags 17 are made from stretchable material impermeable to liquid such as a rubber, and they have first ends 17a opened and second ends 17b closed. The opened first ends 17a are fixed at positions close to the second end block 3 in the second pressure chambers 7b, 8b so as to communicate with the communication path 12 in a liquid-tight manner, and the closed second ends 17b of the bags 17 are disposed so as to come in contact with the second pistons 5b, 6b of the respective racks 5, 6. In this case, it is unnecessary to provide the piston packings 10b for sealing the second pressure chambers 7b, 8b additionally like the first embodiment.

Incidentally, in the embodiment illustrated, the first end 17a of the bag 17 has an opening edge portion 17c for retaining formed so as to be thicker, the opening edge portion 17c is fitted in an inner peripheral portion of a recessed portion 3a formed in the second end block 3, and it is fixed to the recessed portion 3a by large and small retaining rings 18a, 18b. However, anther method can be employed as the fixing method of the bag 17.

In the actuator B of the second embodiment, the bags 17, 17 in the both second pressure chambers 7b, 8b are stretched/shrunk in response to movement of liquid L according to reciprocating movements of the both racks 5, 6 so that reception/discharge of liquid L in/from the bags 17, 17 is repeated. Accordingly, since the liquid L is sealed inside the bag 17 and it is not leaked to the outside, poor operation or pollution in environment due to leakage of the liquid can securely be prevented. Also, the sealing performance is not injured even if the piston packings 10b are not omitted.

Incidentally, since constituents and operations of the second embodiment other than the above-described are substantially the same as those of the first embodiment, the same main constituent portions are denoted by the same reference numerals as those in the first embodiment and explanation thereof will be omitted.

The liquid L used in the respective embodiments may be material having a low viscosity such as water and it may be material having a high viscosity such as oil. By using liquid having a high viscosity such as, for example, silicon oil, an effect of suppressing leakage of the liquid to the minimum can be expected.

In the both embodiments, also, the speeds of the reciprocating stokes of the both racks 5, 6 is reduced by the throttle 13 provided in the communication path 12, but such a constitution can be employed that a check valve 20 is provided in the communication path 12 in parallel to the throttle 13 and the speed of one of forwarding stroke and backward stroke of the reciprocating strokes of the both racks 5, 6 is reduced, for example, as shown with a chain line in FIG. 1.

As understood from the above explanation, according to the present invention, of the first and the second two pressure chambers respectively formed at both sides of the first rack and the second rack, the second pressure chamber which is positioned on the side of back pressure at a driving time of the racks is filled with incompressible liquid, and the second pressure chambers of the both racks are caused to communicate with each other via the throttle, so that influence due to the compressibility of air can be eliminated, thereby operating the racks at low speeds stably.

1. A double racks and pinion type rotary actuator, comprising:
a body provided with two cylinder holes in parallel, and a first end block and a second end block which are mounted to both ends of the body to close end portions of the cylinder holes;
a first rack and a second rack which are received in the respective cylinder holes so as to be movable in a reciprocating manner, and which have a first piston and a second piston at both ends;
a pinion is meshed with the two racks;
first pressure chambers which are formed between the first pistons of the respective racks and the first end block, and second pressure chambers which are formed between the second pistons and the second end block;
a first port which supplies compressed air to the first pressure chamber of the first rack and a second port which supplies compressed air to the first pressure chamber of the second rack;
incompressible liquid which is filled in the second pressure chambers of the both racks, respectively; and
a communication path which causes the second pressure chambers of the both racks to communicate with each other and a throttle which is provided in the communication path.

2. A double racks and pinion type rotary actuator according to claim 1, wherein the first port and the second port are provided in the first end block, and the communication path and the throttle are provided in the second end block.

3. A double racks and pinion type rotary actuator according to claim 1, wherein adjusting screws for adjusting strokes of the racks are provided at positions of the first end block corresponding to the respective racks such that positions thereof are adjustable in a state where distal ends of the adjusting screws have been protruded into the first pressure chambers.

4. A double racks and pinion type rotary actuator according to claim 1, wherein the throttle is a variable throttle which can adjust an opening amount or a fixed throttle having a constant opening amount.

5. A double racks and pinion type rotary actuator according to claim 1, wherein a check valve is provided in the communication path in parallel with the throttle.

6. A double racks and pinion type rotary actuator according to claim 1, wherein bags which are impermeable to liquid and which are stretched/shrunk according to reciprocating movements of the racks are accommodated in the second pressure chambers, and the liquid is filled in the bags.

7. A double racks and pinion type rotary actuator according to claim 6, wherein the bag has an opened first end and a closed second end, the first end is fixed to a position close to the second end block in the second pressure chamber so as to communicate with the communication path in a liquid-tight manner, the second end is disposed so to come in contact with the second piston, and the second piston does not have any seal member for sealing the second pressure chamber.

8. A double racks and pinion type rotary actuator, comprising:
a body provided with two cylinder holes in parallel, and a first end block and a second end block which are mounted to both ends of the body to close end portions of the cylinder holes;
a first rack and a second rack which are received in the respective cylinder holes so as to be movable in a reciprocating manner, and which have a first piston and a second piston at both ends;
a pinion is meshed with the two racks;
first pressure chambers which are formed between the first pistons of the respective racks and the first end block, and second pressure chambers which are formed between the second pistons and the second end block;
a first port for supplying compressed air to the first pressure chamber of the first rack and a second port for supplying compressed air to the first pressure chamber of the second rack, which are respectively provided to the first end block;
incompressible liquid which is filled in the second pressure chambers of the both racks, respectively;
a communication path which is provided in the second end block so as to cause the second pressure chambers of the both racks to communicate with each other, and a variable or fixed throttle which is provided in the communication path; and
adjusting screws for adjusting strokes of the respective racks, which are provided at positions of the first end block corresponding to the respective racks such that distal ends thereof protrude into the first pressure chambers.

9. A double racks and pinion type rotary actuator according to claim 8, wherein a check valve is provided in the communication path in parallel with the throttle.

10. A double racks and pinion type rotary actuator according to claim 8, wherein bags which are impermeable to liquid and which are stretched/shrunk according to reciprocating movements of the racks are accommodated in the second pressure chambers, and the liquid is filled in the bags.

11. A double racks and pinion type rotary actuator according to claim 10, wherein the bag has an opened first end and a closed second end, the first end is fixed to a position close to the second end block in the second pressure chamber so as to communicate with the communication path in a liquid-tight manner, the second end is disposed so to come in contact with the second piston, and the second piston does not have any seal member for sealing the second pressure chamber.

12. A double racks and pinion type rotary actuator according to claim 9, wherein a check valve is provided in the communication path in parallel with the throttle.
